(19) United States
(12) Patent Application Publication
(10) Pub. No.: US 2012/0165478 A1
(43) Pub. Date: Jun. 28, 2012

(54) RUBBER COMPOSITION FOR GOLF BALLS

(75) Inventors: Yuichiro OZAWA, Chichibushi (JP); Jun Shindo, Shinagawaku (JP); Yasuo Fukushima, Kodaira-shi (JP)

(73) Assignees: Bridgestone Corporation, Tokyo (JP); Bridgestone Sports Co., Ltd., Tokyo (JP)

(21) Appl. No.: 12/977,177

(22) Filed: Dec. 23, 2010

(51) Int. Cl. C08L 9/00

(52) U.S. Cl. 525/370

(57) ABSTRACT

The invention provides a rubber composition for golf balls which includes (A) a base rubber containing a polybutadiene having a cis-1,4 bond content of at least 60 wt %, (B) an unsaturated carboxylic acid and/or a metal salt thereof, and (C) two or more organic peroxides which include (C-1) an organic peroxide having a one-minute half-life temperature of 145 to 185° C. and (C-2) an organic peroxide having a one-minute half-life temperature of 110 to 135° C.

The golf ball rubber composition of the invention enables a high-quality molded and crosslinked product having a suitable hardness and a high resilience to be obtained.

### BACKGROUND OF THE INVENTION

The present invention relates to a rubber composition for golf balls which is intended for use in, for example, the core of solid golf balls such as two-piece golf balls and three-piece golf balls. More specifically, the invention relates to a rubber composition which, in a molded and crosslinked form, has a suitable hardness and a good resilience, making it ideal as a golf ball material.

One-piece golf balls, and the solid cores encased, either directly or over an intervening intermediate layer, by a cover in two-piece golf balls and three-piece golf balls, are generally obtained by vulcanizing a rubber composition containing a rubber component such as polybutadiene as the base material and containing also, for example, an unsaturated carboxylic acid metal salt such as zinc acrylate and an organic peroxide. The unsaturated carboxylic acid metal salt serves primarily as a co-crosslinking agent or a crosslinking aid in the rubber composition, and is known to have a large influence on the crosslink structure and crosslink density of the rubber

In addition, peroxide crosslinking is used to crosslink the rubber, this being done with one or more organic peroxide. Recently, there exist in the field of golf balls numerous prior-art documents which describe the use of two or more organic peroxides by utilizing differences in the decomposition temperatures of organic peroxides.

For example, JP-A 9-245234 and JP-A 9-233331 describe the use of organic peroxides having a one-minute half-life temperature of not more than 155° C.

JP-A 11-76462, JP-A 11-57070, JP-A 2004-167052, JP-A 2006-289074 and JP-A 2007-325644 disclose organic peroxides which use dicumyl peroxide and 1,1-bis(t-butylperoxy)-3,3,5-trimethylcyclohexane together.

JP-A 62-122684, JP-A 6-238013 and JP-A 2008-163331 teach rubber compositions for golf balls, which compositions use two or more organic peroxides having different one-minute half-life temperatures. JP-A 2004-167052, JP-A 2007-209472 and JP-A 2009-22465 teach rubber compositions for golf balls which use two or more organic peroxides having different ten-hour half-life temperatures. JP-A 2005-87335 and other publications disclose rubber compositions for golf balls which use organic peroxides focused on the one-hour half-life temperature.

In addition, JP-A 2004-24851 and JP-A 2010-22504 disclose rubber compositions for golf balls which use two or more different organic peroxides and set the ratio between the peroxide having the longest half-life at 155° C. and the peroxide having the shortest half-life in a specific range. JP-A 2004-350953 describes a rubber composition for golf balls which uses an organic peroxide that has been coated with a thermoplastic resin and microencapsulated. Also, JP-A 63-311971 discloses a rubber composition which uses an organic peroxide and has an optimized relationship between the vulcanization temperature and the half-life.

However, in rubber compositions which use two or more specific organic peroxides such as those mentioned above, there are limits on the initial velocity of the golf ball core. In order to further improve the golf ball performance, there exists a desire for golf ball rubber compositions which have an increased core initial velocity while maintaining a suitable hardness.

### SUMMARY OF THE INVENTION

It is therefore an object of the present invention to provide a rubber composition for golf balls which increases the resilience of a molded and crosslinked rubber product owing to the selectivity of the organic peroxide formulated in the rubber composition, and which has a suitable hardness.

The inventors have conducted intensive investigations, as a result of which they have discovered that, when compounding a rubber composition in order to form a one-piece solid golf ball or the core of a solid golf ball having a cover of one or more layer, by including therein a specific polybutadiene-containing base rubber, an unsaturated carboxylic acid and/or a metal salt thereof, and two or more organic peroxides which include (C-1) an organic peroxide having a one-minute half-life temperature of 145 to 185° C. and (C-2) an organic peroxide having a one-minute half-life temperature of 110 to 135° C., molded and crosslinked rubber products obtained from the rubber composition have a suitable hardness and an increased resilience.

Accordingly, the invention provides the following rubber composition for golf balls.

[1] A rubber composition for golf balls, comprising:

(A) a base rubber containing a polybutadiene having a cis-1,4 bond content of at least 60 wt %,

(B) an unsaturated carboxylic acid and/or a metal salt thereof, and

(C) two or more organic peroxides which include (C-1) an organic peroxide having a one-minute half-life temperature of 145 to 185° C. and (C-2) an organic peroxide having a one-minute half-life temperature of 110 to 135° C.

[2] The rubber composition for golf balls of [1] which, in a molded and crosslinked form, is adapted for use as a core.
[3] The rubber composition for golf balls of [1] or [2], wherein organic peroxide C-2 is included in an amount which represents at least 500 of the total organic peroxide content.
[4] The rubber composition for golf balls of [1], [2] or [3], wherein the total content of the organic peroxides of component C is from 0.15 to 15 parts by weight per 100 parts by weight of component A.

### DETAILED DESCRIPTION OF THE INVENTION

The invention is described more fully below.

This invention provides a rubber composition obtained by compounding (A) a base rubber, (B) an unsaturated carboxylic acid and/or a metal salt thereof, and (C) organic peroxides. The formulation of the rubber composition is described in detail below.

Preferred use may be made of polybutadiene as the base rubber serving as component A. In particular, it is recommended that use be made of a polybutadiene having a cis-1,4 bond content on the polymer chain of at least 60 wt %, preferably at least 80 wt %, more preferably at least 90 wt %, and most preferably at least 95 wt %. If the content of cis-1,4 bonds among the bonds on the molecule is too low, the resilience may decrease.

The content of 1,2-vinyl bonds on the polybutadiene is preferably not more than 20, more preferably not more than 1.7%, and even more preferably not more than 1.50, of the bonds on the polymer chain. If the content of 1,2-vinyl bonds is too high, the resilience may decrease.

Rubber components other than the above polybutadiene may be included in above component A within a range that does not detract from the advantageous effects of the invention. Examples of such rubber components other than the above-described polybutadiene include other polybutadienes, and other diene rubbers, such as styrene-butadiene rubber, natural rubber, isoprene rubber and ethylene-propylene-diene rubber.

The unsaturated carboxylic acid and unsaturated carboxylic acid metal salt of component B is included as a co-crosslinking agent.

Examples of the unsaturated carboxylic acid include, but are not limited to, acrylic acid, methacrylic acid, maleic acid and fumaric acid. The use of acrylic acid and methacrylic acid is especially preferred.

The unsaturated carboxylic acid metal salt is exemplified by, but not limited to, the above unsaturated carboxylic acids neutralized with desired metal ions. Illustrative examples include the zinc salts and magnesium salts of methacrylic acid and acrylic acid. Zinc acrylate is especially preferred.

The amount of component B included per 100 parts by weight of the base rubber may be set to preferably at least 10 parts by weight, and more preferably at least 15 parts by weight. The upper limit in the amount included per 100 parts by weight of the base rubber may be set to preferably not more than 60 parts by weight, and more preferably not more than 45 parts by weight. If too much is included, the ball may become too hard, which may result in an unpleasant feel on impact. On the other hand, it too little is included, the rebound may decrease.

The organic peroxides serving as component C are what are referred to as vulcanizing agents or crosslinking agents used for peroxide crosslinking the above rubber molecules. They generate many free radicals by thermal decomposition, dehydrogenating rubber molecule hydrocarbons and generating radicalized rubber molecules.

In this invention, two or more organic peroxides with differing thermal decomposition temperatures are used. Specifically, use is made of both (C-1) an organic peroxide having a one-minute half-life temperature of 145 to 185° C., and (C-2) an organic peroxide having a one-minute half-life temperature of 110 to 135° C. The half-life, one indicator of the rate of decomposition by an organic peroxide, is expressed as the time required, in the course of decomposition by the original organic peroxide, for the amount of active oxygen therein to fall to one-half. That is, the rubber vulcanization temperature for golf balls is generally in a range of 120 to 190° C. Within this range, organic peroxide C-1 having a one-minute half-life temperature of 145 to 185° C. undergoes relatively slow thermal decomposition, whereas organic peroxide C-2 having a one-minute half-life temperature of 110 to 135° C. undergoes relatively rapid thermal decomposition. With the rubber composition of the invention, a complicated spherical crosslinked structure having the desired core properties can be obtained by adjusting the amount of free radicals generated, which amount increases as the vulcanization time elapses.

The organic peroxides used in the invention may be commercial products whose decomposition temperatures for obtaining a one-minute half-life satisfy specific ranges. Examples of the (C-1) organic peroxide having a one-minute half-life temperature (t₁) in a range of 145 to 185° C. include dicumyl peroxide (t₁=175° C.) and 1,1-di(t-butylperoxy)-cyclohexane (t₁=154° C.). Any one of these may be used singly or two or more may be used in combination. Illustrative examples include the organic peroxides available from NOF Corporation under the trade names Percumyl D and Perhexa C-40.

The preferred range for the one-minute half-time temperature (t₁) of (C-1) is 150 to 180° C.

The amount of organic peroxide (C-1) included per 100 parts by weight of the base rubber may be set to preferably at least 0.05 part by weight, and more preferably at least 0.1 part by weight. It is recommended that the upper limit in the amount included per 100 parts by weight of the base rubber be not more than 5 parts by weight, and preferably not more than 3 parts by weight. If the amount included is too low, a sufficient rebound-enhancing effect may not be obtained. On the other hand, if too much is included, a further rebound-enhancing effect is unlikely to occur or the core may become too soft, as a result of which a suitable hardness may not be attainable.

Examples of the organic peroxide (C-2) having a one-minute half-life temperature in a range of 110 to 135° C. include dibenzoyl peroxide (t₁=130° C.) and dilauroyl peroxide (t₁=116° C.). Any one of these may be used singly or two or more may be used in combination. Illustrative examples include the organic peroxides available from NOF Corporation under the trade names Nyper BW and Peroyl L.

The preferred range for the one-minute half-time temperature (t₁) of (C-2) is 113 to 132° C.

The amount of organic peroxide (C-2) included per 100 parts by weight of the base rubber may be set to preferably at least 0.1 part by weight, and more preferably at least 0.2 part by weight. It is recommended that the upper limit in the amount included per 100 parts by weight of the base rubber be not more than 10 parts by weight, and preferably not more than 6 parts by weight. If the amount included is too low, a sufficient rebound-enhancing effect may not be obtained. On the other hand, if too much is included, a further rebound-enhancing effect (particularly on shots with a W#1) is unlikely to occur or the core may become too soft, as a result of which the feel of the ball on impact may worsen.

The total amount of organic peroxide (C) included per 100 parts by weight of the base rubber is set to preferably at least 0.15 part by weight, and more preferably at least 0.3 part by weight. It is recommended that the upper limit in the amount included per 100 parts by weight of the base rubber be not more than 15 parts by weight, and preferably not more than 9 parts by weight. If the amount included is too low, a sufficient rebound-enhancing effect may not be obtained. On the other hand, if too much is included, a further rebound-enhancing effect (particularly on shots with a W#1) is unlikely to occur or the core may become too soft, as a result of which the feel of the ball on impact may worsen.

The amount of organic peroxide (C-2) included by weight is not subject to any particular limitation, although it is preferably at least 500, and more preferably at least 550, of the total organic peroxide content.

Various types of additives may be optionally included in the rubber composition. For example, sulfur, an organosulfur compound, an inert filler, an antioxidant and zinc stearate may be included.

Preferred use may be made of, for example, zinc oxide, barium sulfate or calcium carbonate as the inert filler. These may be used singly or as combinations of two or more thereof.

The amount of inert filler included per 100 parts by weight of the base rubber may be set to preferably at least 1 part by weight, and more preferably at least 5 parts by weight. The upper limit in the amount of inert filler per 100 parts by weight of the base rubber may be set to preferably not more than 200 parts by weight, more preferably not more than 150 parts by weight, and even more preferably not more than 100 parts by weight. Too much or too little inert filler may make it impossible to achieve a proper weight and a good rebound.

The antioxidant used may be a known antioxidant. Illustrative, non-limiting, examples include the commercial products Nocrac NS-6 and Nocrac NS-30 (both available from Ouchi Shinko Chemical Industry Co., Ltd.), and Yoshinox 425 (Yoshitomi Pharmaceutical Industries, Ltd.). These may be used singly or as a combination of two or more thereof.

The amount of antioxidant included may be more than 0, and may be set to an amount per 100 parts by weight of the base rubber which is preferably at least 0.02 part by weight, and more preferably at least 0.05 part by weight. The upper limit in the amount of antioxidant included per 100 parts by weight of the base rubber, although not subject to any particular limitation, may be set to preferably not more than 3 parts by weight, more preferably not more than 2 parts by weight, even more preferably not more than 1 part by weight, and most preferably not more than 0.5 part by weight. Too much or too little antioxidant may make it impossible to achieve a good rebound and durability.

The rubber composition may be obtained by masticating the above ingredients using a conventional mixer (e.g., a Banbury mixer, kneader or roll mill). Next, when using this rubber composition to produce one-piece solid golf balls or solid golf balls having a cover of one or more layer, use may be made of a conventional molding process such as injection molding or compression molding. The vulcanization conditions employed in this case may be ordinary conditions, and may be set as appropriate for, e.g., the size and deflection of the molded and vulcanized product. Vulcanization, which is not subject to any particular limitation, is typically carried out as a single-stage process, although a process in which vulcanization is carried out twice (two-stage vulcanization) may be used.

The vulcanization conditions for the above rubber composition are suitably adjusted according to the type of organic peroxide used, although rubber vulcanization is typically carried out at a temperature in a range of 120 to 190° C. and for a period of from 5 to 60 minutes.

In this invention, the diameter of the molded and crosslinked product (a one-piece solid ball, and the core of a solid golf ball having a cover of one or more layer) formed using the above rubber composition is not subject to any particular limitation, and may be suitably set according to the ball construction.

The deflection of the above molded and crosslinked product when subjected to loading, that is, the deflection (mm) when the molded and crosslinked product is compressed under a final load of 1,275 N (130 kgf) from an initial load of 98 N (10 kgf), although not subject to any particular limitation, may be set to preferably at least 2 mm, and more preferably at least 2.5 mm. It is recommended that the upper limit, although not subject to any particular limitation, be set to preferably not more than 6 mm, and more preferably not more than 5.8 mm. If the deflection is too small, when used in a golf ball, the molded and crosslinked product may be too hard, giving the ball a hard feel on impact, in addition to which the spin rate on shots with a driver may increase, possibly resulting in a decline in the distance traveled by the ball. On the other hand, when the deflection is too large, the golf ball may not achieve a sufficient rebound, possibly lowering the distance traveled by the ball.

In the present invention, in the case of solid golf balls wherein the above molded and crosslinked product is used as the core and the core is encased by a cover of one or more layer, the cover may be formed of a known material. More specifically, used may be made of an ionomer resin, a polyester-type thermoplastic elastomer, a polyamide-type thermoplastic elastomer, a polyurethane-type thermoplastic elastomer, an olefin-type thermoplastic elastomer, or a mixture thereof. Commercial products may be used as these materials. Illustrative examples of such products include Himilan (ionomer resins available from DuPont-Mitsui Polychemicals Co., Ltd.), Surlyn (ionomer resins available from E.I. DuPont de Nemours & Co.), Iotek (ionomer resins available from ExxonMobil Chemical).

Various additives, such as ultraviolet absorbers, antioxidants, metal soaps, pigments and inorganic fillers, may be suitably included in the above-described cover material.

The above cover may be formed by a known process, such as injection molding or compression molding. For example, in cases where the cover is formed by injection molding, a core that has been fabricated beforehand using the above rubber composition may be set inside a cover-forming mold and the cover material injected into the mold according to an ordinary method. In another process that may be used, a pair of half-cups is molded beforehand using the above-described cover material, following which the core is enclosed by these half-cups, and compression molding is carried out at, for example, from 120 to 170° C. for a period of 1 to 5 minutes.

When the cover is formed in this way, the cover thickness is not subject to any particular limitation, but may be set to preferably at least 0.2 mm, and more preferably at least 0.4 mm. The upper limit is not subject to any particular limitation. When the cover is composed of a plurality of two or more layers, the total thickness of all the layers should fall within the above range.

The deflection of the golf ball in which the above molded and crosslinked product has been used, that is, the deflection (mm) of the molded and crosslinked product when subjected to compression at a final load of 1,275 N (130 kgf) from an initial load state of 98 N (10 kgf), although not subject to any particular limitation, may be set to preferably at least 2 mm, and more preferably at least 2.2 mm. It is recommended that the upper limit in the deflection, although not subject to any particular limitation, be set to preferably not more than 6 mm, and more preferably not more than 5.5 mm. In cases where a cover is not formed and the molded and crosslinked product is used as a one-piece solid golf ball, the deflection is not subject to any particular limitation, but is recommended to be the same as the deflection for golf balls in which the above-described cover has been formed.

In golf balls obtained using the above molded and crosslinked product, although not subject to any particular limitation, to further improve the aerodynamic properties and increase the distance, it is possible, as in conventional golf balls, to form a large number of dimples on the surface. By optimizing the dimple parameters such as the types and total number of dimples, a ball having a more stable trajectory and an excellent flight performance can be obtained. To enhance the design and durability of the golf ball, various treatments, such as surface preparation, stamping and painting, may be carried out on the surface of one-piece solid golf balls or the surface of the cover on solid golf balls having a cover of one or more layer.

Golf balls obtained using the above molded and crosslinked product may be manufactured so as to conform to the Rules of Golf for competitive play. It is preferable to set the ball diameter to not less than 42.67 mm, and the weight to not more than 45.93 g.

As described above, the inventive rubber composition for golf balls is a high-quality composition having a suitable hardness and a high resilience. In particular, by employing this as a one-piece golf ball material or as a solid core material in multi-piece solid golf balls, golf balls having a high initial velocity, an increased distance and a good feel can be obtained. Moreover, the rubber compositions have an increased crosslinking rate during molding and vulcanization, resulting in a high productivity for the molded product.

### EXAMPLES

Examples of the invention and Comparative Examples are given below by way of illustration, and not by way of limitation.

### Examples 1 to 11, Comparative Examples 1 to 3

Rubber compositions were formulated as shown in Table 1 below, then molded and vulcanized at 155° C. for 20 minutes to form cores having a diameter of 38.7 mm.

TABLE 1

| | | Comparative | | | | | | | | | | | | | |
|---|---|---|---|---|---|---|---|---|---|---|---|---|---|---|---|
| | | Example | | | Example | | | | | | | | | | |
| | | 1 | 2 | 3 | 1 | 2 | 3 | 4 | 5 | 6 | 7 | 8 | 9 | 10 | 11 |
| Formulation | Polybutadiene | 100 | 100 | 100 | 100 | 100 | 100 | 100 | 100 | 100 | 100 | 100 | 100 | 100 | 100 |
| (pbw) | Zinc oxide | 22 | 22 | 22 | 22 | 22 | 22 | 22 | 22 | 22 | 22 | 22 | 22 | 22 | 22 |
| | Antioxidant | 0.1 | 0.1 | 0.1 | 0.1 | 0.1 | 0.1 | 0.1 | 0.1 | 0.1 | 0.1 | 0.1 | 0.1 | 0.1 | 0.1 |
| | Zinc acrylate | 30 | 27 | 24 | 30 | 30 | 30 | 27 | 27 | 27 | 27 | 27 | 27 | 27 | 24 |
| | Organic | 0.3 | 0.3 | 0.3 | 0.4 | 0.3 | | 0.2 | 0.3 | 0.4 | 0.4 | 0.4 | 0.4 | 0.3 | 0.3 |
| | peroxide (1) | | | | | | | | | | | | | | |
| | Organic | 0.3 | 0.3 | 0.3 | | | 0.5 | | | | | | | | |
| | peroxide (2) | | | | | | | | | | | | | | |
| | Organic | | | | 2 | | | | | | | | | | |
| | peroxide (3) | | | | | | | | | | | | | | |
| | Organic | | | | | 2 | 2 | 1.5 | 1.5 | 1.5 | 2 | 1 | 0.5 | 2 | 2 |
| | peroxide (4) | | | | | | | | | | | | | | |
| Properties | Core deflection | 3.1 | 3.5 | 4.2 | 3.1 | 3.0 | 3.3 | 3.7 | 3.2 | 3.0 | 3.0 | 3.0 | 3.2 | 3.2 | 3.7 |
| | (mm) | | | | | | | | | | | | | | |
| | Core initial | 77.7 | 77.4 | 77.0 | 77.9 | 78.2 | 77.8 | 77.9 | 78.2 | 78.3 | 78.4 | 78.3 | 78.0 | 78.2 | 77.9 |
| | velocity (m/s) | | | | | | | | | | | | | | |

Details on the materials in Table 1 are given below.
Polybutadiene: Available under the trade name “BR 730” from JSR Corporation.
Zinc oxide (zinc white): Available from Sakai Chemical Co., Ltd.
Antioxidant: 2,2′-Methylenebis(4-methyl-6-t-butylphenol), available under the trade name “Nocrac NS-6” from Ouchi Shinko Chemical Industry Co., Ltd.
Zinc acrylate: A mixture of 85 wt % zinc acrylate and 15 wt % zinc stearate. Available from Nihon Jyoryu Kogyo Co., Ltd.
Organic peroxide (1): Dicumyl peroxide, available from NOF Corporation under the trade name “Percumyl D” (one-minute half-life temperature, 175° C.)
Organic peroxide (2): 1,1-Di(t-butylperoxy)cyclohexane, 400 concentration. Available from NOF Corporation under the trade name
“Perhexa C-40” (one-minute half-life temperature, 154° C.)
Organic peroxide (3): Dibenzoyl peroxide, available from NOF Corporation under the trade name “hyper BW” (one-minute half-life temperature, 130° C.)
Organic peroxide (4): Dilauroyl peroxide, available from NOF Corporation under the trade name “Peroyl L” (one-minute half-life temperature, 116° C.)

The deflections and initial velocities for each of the cores obtained were measured by the following methods. The results are shown in Table 1.

### (1) Core Deflection (mm)

The core deflection (mm), when compressed at a rate of 10 mm/s under a final load of 1,275 N (130 kgf) from an initial load state of 98 N (10 kgf), was measured at a temperature of 23±1° C.

(2) Core Initial Velocity Test (m/s)

The initial velocity of the core was measured using an initial velocity measuring apparatus of the same type as the USGA drum rotation-type initial velocity instrument approved by the R&A. The core was held isothermally at a temperature of 23±1° C. for at least 3 hours, then tested in a room temperature (23±2° C.) chamber.

As shown in Table 1, higher core initial velocities were obtained for the rubber compositions in Examples 1 to 11 according to the present invention than for the rubber compositions in Comparative Examples 1 to 3. In particular, on comparing examples of the invention and comparative examples in which the same amounts of zinc acrylate were included as a co-crosslinking agent, it was apparent that the core initial velocities were higher in the examples of the invention.

1. A rubber composition for golf balls, comprising:
(A) a base rubber containing a polybutadiene having a cis-1,4 bond content of at least 60 wt %,
(B) an unsaturated carboxylic acid and/or a metal salt thereof, and
(C) two or more organic peroxides which include (C-1) an organic peroxide having a one-minute half-life temperature of 145 to 185° C. and (C-2) an organic peroxide having a one-minute half-life temperature of 110 to 135° C.

2. The rubber composition for golf balls of claim 1 which, in a molded and crosslinked form, is adapted for use as a core.

3. The rubber composition for golf balls of claim 1, wherein organic peroxide C-2 is included in an amount which represents at least 50% of the total organic peroxide content.

4. The rubber composition for golf balls of claim 1, 2 or 3, wherein the total content of the organic peroxides of component C is from 0.15 to 15 parts by weight per 100 parts by weight of component A.
